(19) United States
(12) Patent Application Publication
(10) Pub. No.: US 2015/0221402 A1
(43) Pub. Date: Aug. 6, 2015

(54) STORAGE SYSTEM FOR NUCLEAR FUEL

(71) Applicant: HOLTEC INTERNATIONAL ,INC., Marlton, NJ (US)

(72) Inventor: Krishna P. Singh, Hobe Sound, FL (US)

(21) Appl. No.: 14/367,705

(22) PCT Filed: Dec. 24, 2012
(86) PCT No.: PCT/US2012/071591

§ 371 Date: Jun. 20, 2014

Related U.S. Application Data
(60) Provisional application No. 61/579,455, filed on Dec. 22, 2011.

(51) Int. Cl. G21C 19/07

(52) U.S. Cl. CPC G21C 19/07

(57) ABSTRACT

A high-density fuel rack and system for wet storage of radio-active fuel, assemblies, such as spent nuclear fuel. The fuel rack includes a grid array of elongated cells each con figured for holding a fuel assembly, in one aspect, the cells are formed by a plurality of longitudinally-extending tubes having a rectilinear polygonal cross-sectional configuration. In one embodiment, the cells may have a cross-sectional shape of unequal width and length. The tubes may be variously arranged in contiguous or spaced apart configurations for non-flux trap and flux trap type racks, respectively.

### CROSS-REFERENCE TO RELATED PATENT APPLICATIONS

The present application claims the benefit of U.S. Provisional Patent Application Ser. No. 61/579,455, filed Dec. 22, 2011, the entirety of which is hereby incorporated by reference.

### FIELD OF THE INVENTION

The present invention relates generally to apparatuses for supporting high level radioactive waste, and more specifically to wet storage apparatuses and systems for supporting and holding radioactive fuel assemblies in a fuel pool.

### BACKGROUND OF THE INVENTION

In the nuclear power industry, the nuclear energy source is typically in the form of hollow zircaloy tubes filled with enriched uranium, known as fuel assemblies. Upon being deleted to a certain level, spent fuel assemblies are removed from a reactor. At this time, the fuel assemblies not only emit extremely dangerous levels of neutrons and gamma photons (i.e., neutron and gamma radiation) but also produce considerable amounts of heat that must be dissipated.

It is necessary that the neutron and gamma radiation emitted from the spent fuel assemblies be adequately contained at all times upon being removed from the reactor. It is also necessary that the spent fuel assemblies be cooled. Because water is an excellent radiation absorber, spent fuel assemblies are typically submerged under water in a pool promptly after being removed from the reactor. The pool water also serves to cool the spent fuel assemblies by drawing the heat load away from the fuel assemblies. The water may also contain a dissolved neutron shielding substance.

The submerged fuel assemblies are typically supported and stored in the fuel pools in a generally upright orientation in rack structures, commonly referred to as fuel racks. It is well known that neutronic interaction between fuel assemblies increases when the distance between the fuel assemblies is reduced. Thus, in order to avoid criticality (or the danger thereof) that can result from the mutual inter-reaction of adjacent fuel assemblies in the racks, it is necessary that the fuel racks support the fuel assemblies in a spaced manner that allows sufficient neutron absorbing material to exist between adjacent fuel assemblies. The neutron absorbing material can be the pool water, a structure containing a neutron absorbing material, or combinations thereof.

Fuel racks for high density storage of fuel assemblies (i.e. minimized cell-to-cell spacings) are commonly of a cellular grid array construction with neutron absorbing plate structures (i.e., shields) placed between individual cells in the form of solid sheets and/or a neutron absorbing material integrated into the cell structure itself. The individual cells are each usually elongated vertical tubes which are open at the top through which individual fuel elements are inserted. The cells sometimes include double walls that encapsulate the neutron shield sheets to protect the neutron shield from corrosion or other deterioration resulting from contact with water. Each fuel assembly is placed in a separate cell so that the fuel assemblies are shielded from one another.

One so-called high density spent fuel rack to store light-water reactor fuel is a prismatic structure with relatively tightly packed square cross section cells that serve to store fuel assemblies that are correspondingly square in their cross section. State-of-the-art fuel racks are designed in two distinct geometries, namely a non-flux trap type rack and flux trap type rack.

The key identifier of a non-flux trap rack design is the absence of any water gap between the contiguous storage cells where fuel is stored. Non-flux trap racks are used to store pressurized water reactor (PWR) fuel that has been burned in the reactor and has lost some of its fissionable material (U-235) or (the smaller cross section) fuel used in boiling water reactors (BWR).

A flux trap rack is characterized by an engineered water gap between the contiguous storage cells. The width of the water gap is adjusted by the designer to ensure that the reactivity of the storage array remains within the regulatory limit (e.g. 0.95 in the U.S.). The flux trap rack design is necessary to store fuel that is fresh and has high initial enrichment (over 4.5% U-235), typical of operating PWRs today.

In the present state-of-the-art, adjusting the opening size of the square cells is the only variable available to the rack designer of a non-flux trap rack. Based on the operating experience in the industry, the minimum cell opening size must be roughly 0.4 inch larger than the fuel cross section to ensure that fuel somewhat distorted by irradiation will still fit in tire storage cavity. In the case of a flux trap rack, the designer has one more parameter at his or her disposal, namely, the width of the water gap (formally known, as the “flux trap”).

When designing rack modules for a pre-existing pool, the designer typically laces an unequal rectangular planform area formed by the floor slab of the pool on which an array of rack modules are installed. Maximizing the number of storage cells and minimizing the reactivity of the storage system are the two design objectives in configuring the fuel rack storage array. As would be expected, in most cases the rack modules do not fit the pool plan form area precisely, leading to unused peripheral space in the pool. Fuel pools in use at LWR plants around the world today suffer from varying amounts of unused valuable pool floor space.

A fuel rack system is desired that reduces or eliminates this underutilization of pool floor space by using the unused space to reduce the reactivity in the pool or, in some cases, increase the overall storage capacity of spent fuel assemblies in the fuel pool.

### SUMMARY OF THE INVENTION

One embodiment of a fuel rack according to principles of the present disclosure is directed to an ortho-unsymmetric (non-square) fuel assembly storage cell configured such that the lateral cross sectional dimensions of the cell in two orthogonal directions (e.g. X and Y) is unequal. In one embodiment, the cells each have an unequal rectangular cross section. This arrangement provides that there is little or no unused peripheral space on the floor slab of the fuel pool with the provision that both the X and Y dimensions of each cell be greater than or equal to the minimum required opening size to permit smooth handling of the irradiated fuel assembly (i.e. insertion into or withdrawal from the storage cells).

By adopting the unequal rectangular (non-square) cell cross section, the quantity of water around the fuel inside the boundary of the neutron absorber in a non-flux type rack design is maximized which, criticality calculations show, results in minimization of the reactivity of the storage system. Thus, by using the untapped peripheral space in the fuel pool, the reactivity (measured by the neutron multiplication factor keff) in the pool is advantageously reduced. The designer can take advantage of the reduction in k-eff due to improved utilization of the pool floor space to ensure a larger safety margin in the storage system or reduce the quantity of the B-10 isotope (e.g. Boral) specified in the neutron absorber appropriately to realize cost savings.

In flux trap rack designs, this design concept is even more effectively used by adjusting the water gap (water gap between facing vertical panels of neutron absorber) in the two orthogonal directions to exploit all of the available pool floor space. Calculations show that it is the average of the two orthogonal water gaps that governs the level of reactivity. Thus, if the required square layout gap is “d,” the gap in the X and Y direction can be increased and decreased from “d” such that their average is greater than “d” by only a small amount (e.g. 5% in some possible embodiments). The designer can, however, adjust the two orthogonal gaps suitably to exploit ail of the available pool floor space by providing a system comprised of a plurality of fuel racks so designed. It can be readily deduced that adoption of the unequal water gap strategy will enable maximum utilization of the pool floor space, leading to a larger storage cell count, or to a reduced k-eff for the storage system, or both.

According to one embodiment, a fuel rack for supporting radioactive fuel assemblies includes a grid array of elongated cells defining a longitudinal axis and configured for immersion into a fuel pool, each cell comprising a plurality of walls having inner surfaces defining a longitudinally-extending cavity configured for holding a radioactive fuel assembly. The cells have a rectilinear polygonal configuration in lateral cross section formed by a first pair of parallel spaced apart walls defining a length and a second pair of parallel spaced apart walls defining a width, wherein the length is greater than the width of the cells. In one embodiment, the grid array of cells is formed by a plurality of longitudinally tubes each having sidewalls with inner surfaces defining the cavity that forms the cell; the tubes being arranged in an axially aligned and adjacent manner. The fuel rack may a non-flux type rack. According to another embodiment, a fuel rack for supporting radioactive fuel assemblies includes a grid array of elongated tubes defining a longitudinal axis and configured for immersion into a fuel pool, each tube comprising a plurality of sidewalls having inner surfaces defining a longitudinally-extending cavity configured for holding a radioactive fuel assembly. The tubes have a rectilinear polygonal configuration in lateral cross section formed by a first pair of parallel spaced apart sidewalls walls defining a length and a second pair of parallel spaced apart sidewalls defining a width. The tubes are each spaced apart from one another forming flux trap spaces between sidewalls of adjacent tubes. The flux trap spaces comprise first flux trap spaces between tubes measured along a first orthogonal axis and forming a first gap having a first distance separating tubes, and second flux trap spaces between tubes measured along a second orthogonal axis each forming a second gap have a second distance separating tubes. The first distance is different than the second distance forming unequal flux trap spaces. In one embodiment, the tubes have a rectilinear polygonal configuration in lateral cross section. In the foregoing embodiment, the tubes may have a square rectilinear polygonal configuration in lateral cross section. The fuel rack may be a flux type rack.

A fuel storage system for radioactive fuel assemblies is provided. In one embodiment, the system includes a fuel pool comprising water and a floor slab defining a planar surface area, a plurality of fuel racks positioned on the floor slab of the fuel pool, the fuel racks each comprising a grid array of elongated cells defining a longitudinal axis and being formed by a plurality of walls having inner surfaces defining a longitudinally-extending cavity configured for holding a radioactive fuel assembly. Each fuel, rack has a length and a width in top plan view, the length and width being different and unequal. In one embodiment, the plurality of fuel racks occupy greater than 85% of the available planar surface area of the floor slab of the fuel pool. In another embodiment, the plurality of fuel racks occupy approximately 100% of the useable available planar surface area of the floor slab of the fuel pool.

### BRIEF DESCRIPTION OF THE DRAWINGS

FIG. 1 is a top perspective view of a fuel rack according to one embodiment of the present disclosure.

FIG. 2 is a top perspective view of a fuel rack according to a second embodiment of the present disclosure.

FIG. 3 is a top plan view of the fuel rack of FIG. 1.

FIG. 4 is a top plan view of the fuel rack of FIG. 2.

FIG. 5 is a top plan view of a fuel rack system including a plurality of the fuel racks of FIG. 1 arranged on a floor slab of a wet storage fuel pool, the fuel racks each having an unsymmetrical configuration and overall outer dimensions in plan view.

FIG. 6 is top perspective view of a fuel rack according to a third embodiment of the present disclosure constructed of a plurality of interlocking slotted plates.

FIG. 7A is a perspective view of first slotted plate used in the construction of the fuel rack of FIG. 6.

FIG. 7B is a perspective view of a second slotted plate used in the construction of the fuel rack of FIG. 6.

FIG. 7C is a perspective view of a third slotted plate used in the construction of the fuel rack of FIG. 6.

FIG. 8 is a perspective view of a vertical section of slotted plates of the fuel rack of FIG. 6.

All drawings are schematic and not necessarily to scale.

### DETAILED DESCRIPTION OF THE DRAWINGS

The features and benefits of the invention are illustrated and described herein by reference to exemplary embodiments. This description of exemplary embodiments is intended to be read in connection with the accompanying drawings, which are to be considered part of the entire written description. In the description of embodiments disclosed herein, any reference to direction or orientation is merely intended far convenience of description and is not intended in any way to limit the scope of the present invention. Relative terms such as “lower,” “upper,” “horizontal,” “Vertical,”, “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise. Accordingly, the disclosure expressly should not be limited to such exemplary embodiments illustrating some possible non-limiting combination of features that may exist alone or in other combinations of features.

### I. Non-Flux Trap Fuel Rack Embodiment

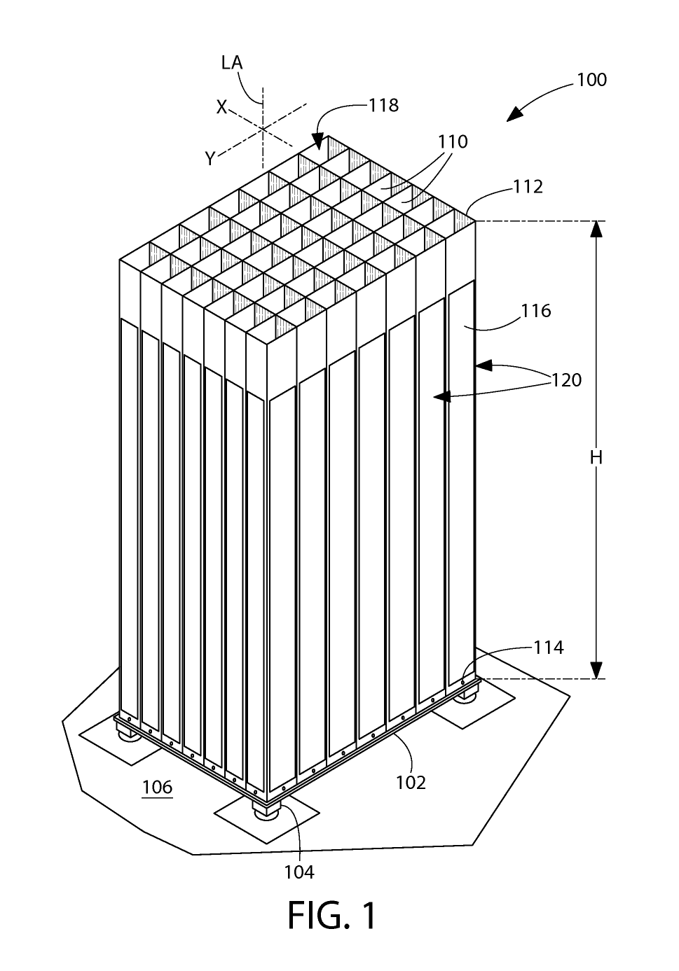

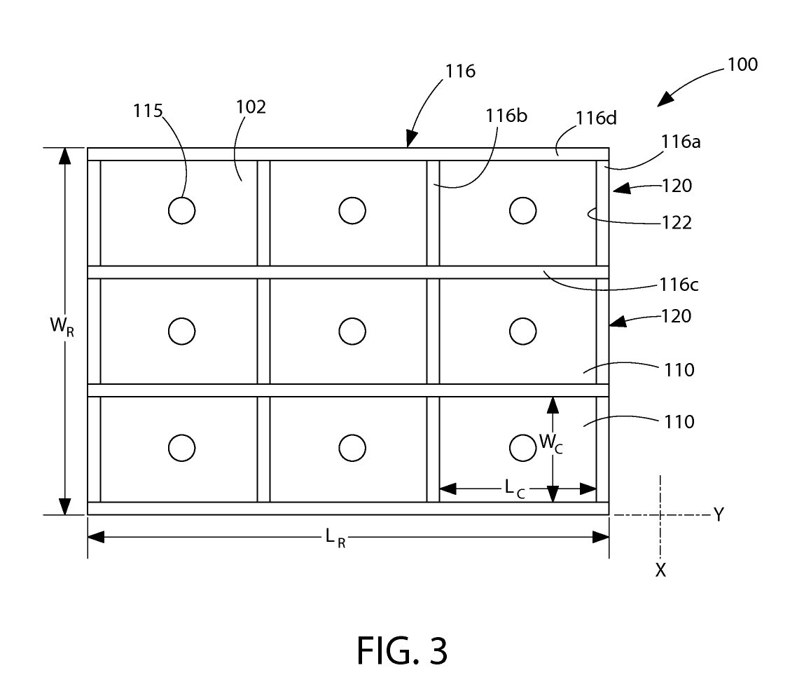

Referring to FIG. 1, a perspective view of a fuel rack 100 according to one embodiment of the present invention is disclosed. The fuel rack 100 is a cellular, upright, prismatic module. Fuel rack 100 is a high density, tightly packed non-flux type rack designed to be used with fuel assemblies that do not require the presence of a neutron flux trap between adjacent cells 110. Thus, the inclusion of neutron flux traps in fuel racks when not needed is undesirable because valuable fuel pool floor area is unnecessarily wasted. Of course, both non-flux and flux fuel rack types 100, 200 may be stored side by side in the same pool. FIG. 3 depicts a top plan view of a portion of fuel rack 100.

In describing fuel racks 100, 200, and 300 which follows, and their component parts below, relative terms such as top, bottom, above, below, horizontal, vertical, tipper, lower, and other terms of position and orientation will be used in relation to the fuel racks being in the illustrated substantially vertical orientation as they would be when immersed and positioned on a floor slab 106 of a fuel pool. Accordingly, the present invention is expressly not limited by these terms of description used for convenience in describing exemplary embodiments disclosed herein. Additionally, in order to avoid clutter in the drawings, only a few of each component are numbered with the understanding that the reader will be able to identity duplicate elements.

Fuel rack 100 defines a longitudinal axis as shown in FIG. 1 and comprises a grid array of closely packed cells 110 formed by a plurality of adjacent elongated tubes 120 arranged in parallel axial relationship to each other. Tubes 120 are coupled to a planar top surface of a base plate 102 and extend upwards in a substantially vertical orientation. In this embodiment, the axis of each tube 120 is not only substantially vertical, but also substantially perpendicular to the top surface of the base plate 102. In one embodiment, tubes 120 may be fastened to base plate 102 by welding or mechanical coupling such as bolting, clamping, threading, etc.

Tubes 120 include a top end 112, bottom end 114, and a plurality of longitudinally vertical sidewalls 116 between the ends defining a height H. Each tube 120 defines an internal cavity 118 extending between the top and bottom ends 112, 114. In the embodiment shown in FIG. 1, four sidewalls arranged in rectilinear polygonal relationship are provided forming a rectangular tube 120 in lateral cross section (i.e. transverse or orthogonal to longitudinal axis LA) in plan or horizontal view (see also FIG. 3). Cells 110 and internal cavities 118 accordingly have a corresponding rectangular configuration in lateral cross section. The top ends of the tubes 220 are open so that a fuel assembly can be slid down into the internal cavity 118 formed by the inner surfaces of the tube sidewalk 116.

It will be appreciated that each tube 120 can be forms as a single unitary structural component that extends the entire desired height H or can be constructed of multiple partial height tubes that are connected together such as by welding or mechanical means which collectively add up to the desired height H. It is preferred that the height H₁ of the tubes 120 be sufficient so that the entire height of a fuel assembly may be contained within the tube when the fuel assembly is inserted into the tube.

Referring to FIG. 1, each fuel rack 100 may be viewed to define a transverse X-Y coordinate system perpendicular to longitudinal axis LA and therein defining a horizontal plane. As best shown in FIG. 3, tubes 120 are geometrically arranged atop the base plate 102 in rows and columns. FIGS. 1 and 3 depict a non-limiting example of a 7×7 tube array for discussion purposes. Any suitable array size including unequal arrays (e.g. 7×8, 8×10, etc.) may be provided depending on the horizontal length and width of the pool floor slab 106 and number of fuel racks 100 to be provided so long as the fuel racks 100 have unequal width and length as to best make use of a maximum amount of available slab surface area as possible, as further described herein.

As best shown in FIG. 3, tubes 120 which define cells 110 may share one or more common sidewalls 116 with adjacent cells in some configurations as shown. Such arrangements may be formed, for example, by welding sidewall plates together to form a completed fuel rack. Alternatively, each tube 120 may be complete in itself and self-supporting being formed by four sidewalls 116 comprising two pairs of parallel arranged sidewalls. Tubes 120 may be formed by sidewalk 116 which are integrally fanned as a single unitary structure such as by extrusion, or in some embodiments may be individual plates of material which are welded together to form a tubular shape. Any suitable method and construction for forming tubes 120 may be used.

Referring to FIG. 3, each tube 120 includes a first pair of parallel spaced apart opposing sidewalls 116a and 116b, and a second pair of parallel spaced apart opposing sidewalls 116c and 116d. The inner surfaces of sidewalls 116a-116d define a cell width Wc and cell length Lc measured in the X-Y horizontal plane. The cell grid array in turn collectively defines a fuel rack width WR and rack length LR formed by the outer surfaces of the outermost sidewalls 116a-116d. In one preferred embodiment, shown in FIG. 3, the cell length Lc is greater than the cell width Wc and form a tube 120 and corresponding cell 110 having a rectangular transverse or lateral cross section with unequal sidewalls. In other embodiments, cell width Wc may be greater than cell length Lc.

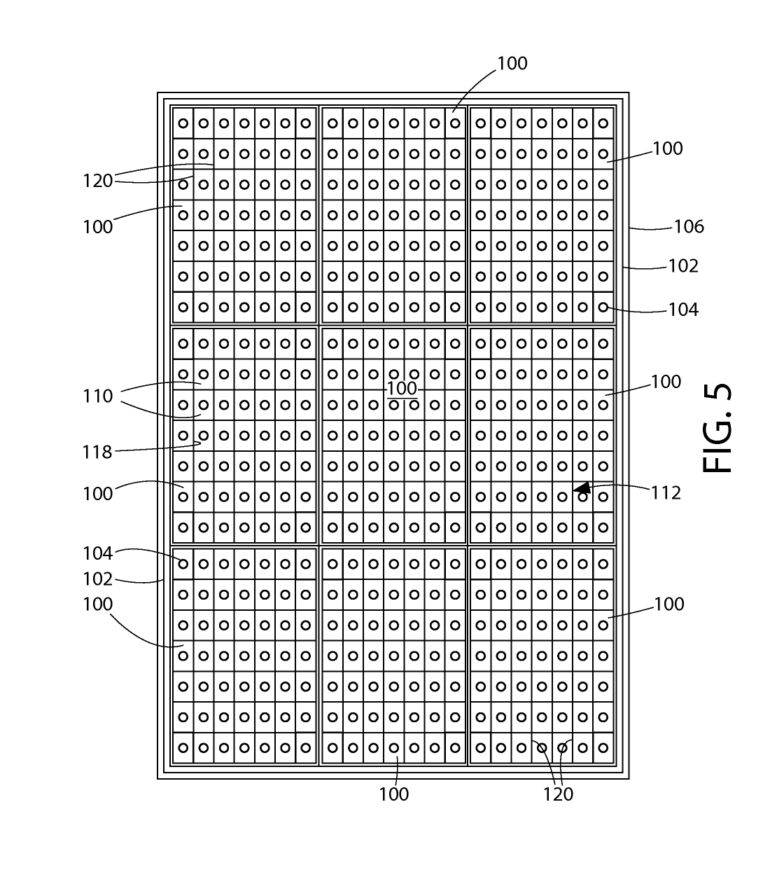

One skilled in the art may adjust the width Wc and length Lc of the cells 110 defined by each tube 120 in each rack 100, and the total number of racks to utilize a maximum amount of the fuel pool floor slab surface area as possible. Since the minimum cross-sectional cell dimensions are dictated by industry practice and criticality safety margin, the minimum size requirement may be exceeded to fully utilize the existing fuel pool floor slab area providing a greater fuel assembly storage capacity. In one embodiment, as shown in FIG. 5, essentially all of the available useable surface area of floor slab 106 in the fuel pool (allowing for minimal clearance between adjacent fuel racks 100 and a small perimeter clearance between the vertical pool walls and racks) may be utilized resulting in the arrangement shown. Such a fuel storage system as shown is comprised of a plurality of fuel racks 100 which preferably occupy greater than 85% of the available usable surface area of floor slab 106, more preferably greater than 90%, and most preferably greater than 95% of the available usable surface area. In one embodiment, about 100% of the available usable surface area of floor slab 106 is utilized by planned and predetermined configuration of each fuel rack 100 and tube 120 cross-sectional dimensions (i.e. width Wc and length Lc).

Optionally, in other embodiments, the critically safety margin may be increased thereby reducing the quantity of B-10 isotope used in the neutron absorption material.

Tubes 120 may be constructed of a metal-matrix composite material, and preferably a discontinuously reinforced aluminum/boron carbide metal matrix composite material, and more preferably a boron impregnated aluminum. One such suitable material is sold under the tradename Metamic™. The tubes 120 perform the dual function of reactivity control as well as structural support. Advantageously, tube material incorporating the neutron absorber material allows a smaller cross sectional (i.e. lateral or transverse to longitudinal axis LA) thickness of tube sidewalls 116 thereby permitting tighter packing of cells allowing for a greater number of cells per fuel rack to be provided. The base plate 102 is preferably constructed of a metal that is metallurgically compatible with the material of which the tubes 120 are constructed for welding.

Referring to FIG. 3, base plate 102 may also include a plurality of flow holes 115 extending through the base plate from its bottom surface to its top surface. The flow holes 115 create passageways from below the base plate 102 into the cells 110 formed by the tubes 120. Preferably, a single flow hole 115 is provided for each cell 110. The flow holes 115 are provided as inlets to facilitate natural thermosiphon flow of pool water through the cells 110 when fuel assemblies having a heat load are positioned therein. More specifically, when heated fuel assemblies are positioned in the cells 110 in a submerged environment, the water within the cells 110 surrounding the fuel assemblies becomes heated, thereby rising due to decrease in density and increased buoyancy creating a natural upflow pattern. As this heated water rises and exits the cells 110 via the tube open top ends 112 (see FIG. 1), cooler water is drawn into the bottom of the cells through the flow holes 115. This heat induced water flow and circulation pattern along the fuel assemblies then continues naturally to dissipate heat generated by the assemblies.

Referring back to FIGS. 1 and 3, base plate 102 also includes a plurality of adjustable height pedestals 104 connected to the bottom surface of the base plate 102. In one embodiment, for example without limitation, the adjustment means may be accomplished via a threaded pedestal assembly. The adjustable height pedestals 1-4 ensure that a space exists between the floor slab 106 of the fuel pool and the bottom surface of the base plate 110, thereby creating an inlet plenum for water to flow upwards through the flow holes 115 and cells 110.

The adjustable height pedestals 104 are spaced to provide uniform support of the base plate 102 and thus the fuel rack 100. Each pedestal 104 is preferably individually adjustable to level and support the fuel rack on a non-uniform spent fuel pool floor slab 106. The pedestals 104 may be bolted to the base plate 110 in some embodiments. Of course, in other embodiments, the pedestals 104 can be attached to base plate 102 by other means, including without limitation welding or threaded attachment. In the event of a welded pedestal 104, an explosion-bonded stainless-aluminum plate may be used to make the transition.

### II. Flux Trap Fuel Rack Embodiment

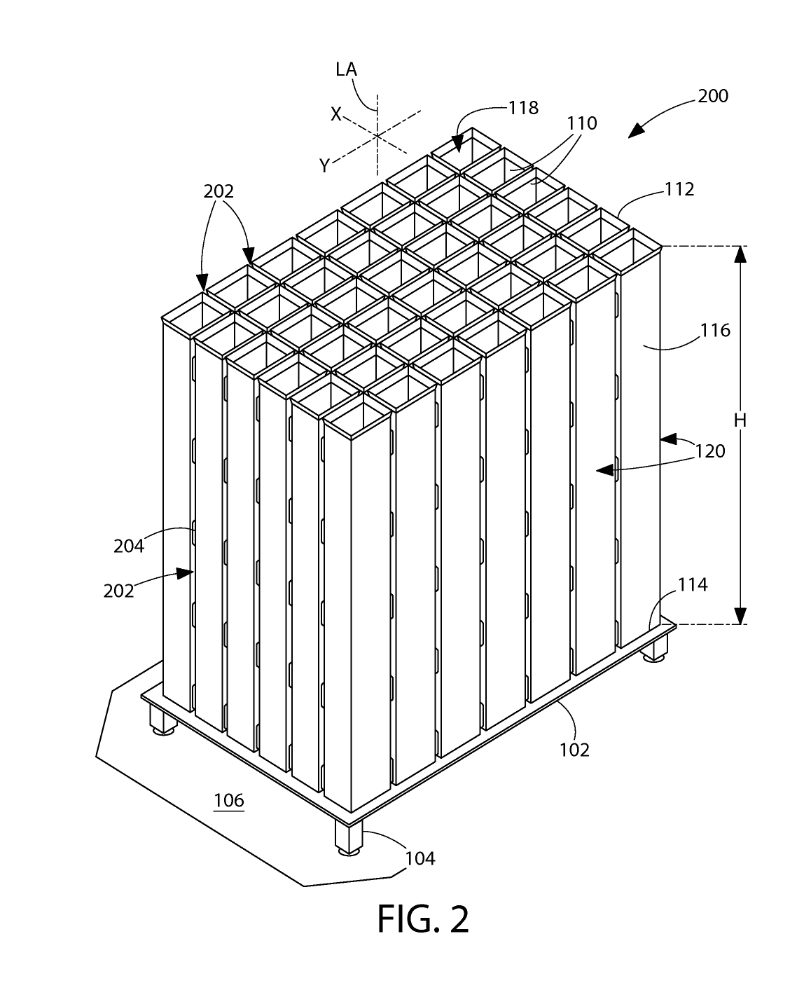

Referring to FIG. 2, a perspective view of a flux trap type fuel, rack 200 according to another embodiment of the present invention is disclosed. Similar to the non-flux type fuel rack 100 shown in FIG. 1 and described herein, fuel rack 200 is similarly a cellular, upright, prismatic module. Because many of the structural and functional features of the fuel rack 200 are identical to the fuel rack 100, only those aspects of the fuel rack 200 that are significantly different will be discussed below with the understanding that the other concepts discussed above with respect to fuel rack 100 are applicable.

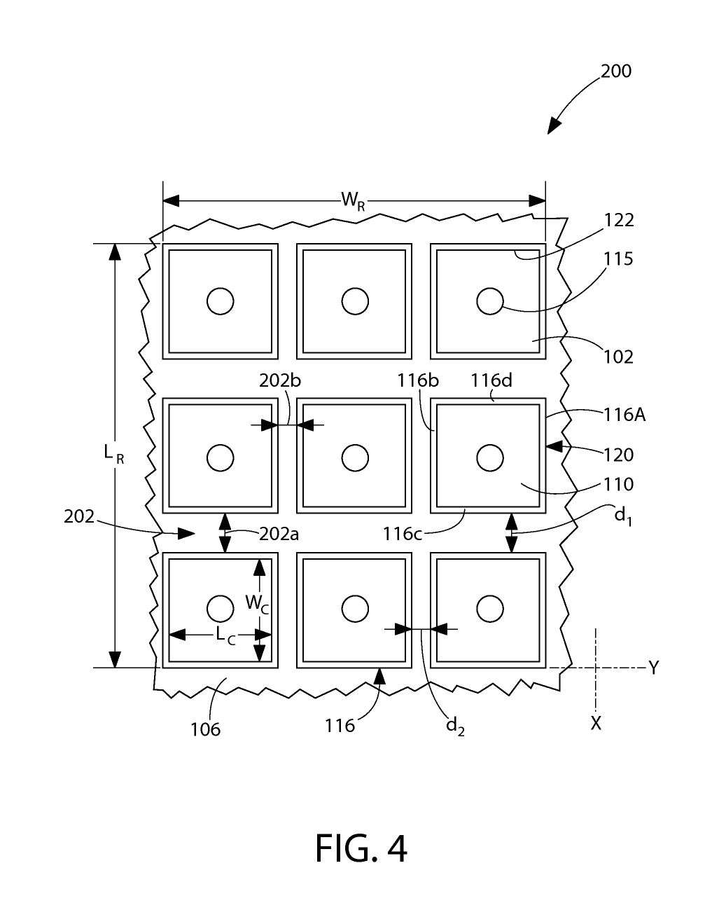

FIG. 4 is a top plan view of a portion of fuel rack 200 shown in FIG. 2.

Referring to FIGS. 2 and 4, tubes 120 may be of the same general construction as in fuel rack 100 but with a different physical layout and arrangement on base plate 102. Tubes 120 in this embodiment are connected to the top surface of the base plate 102 in a substantially vertical orientation and spaced laterally/transversely apart from one another in the X-Y horizontal plane to form flux trap spaces 202 between immediately adjacent tubes.

Accordingly, in the flux trap type fuel rack, it should be noted that longitudinally sidewalls 516 of one cell 110 are not shared in common to form part of adjacent cells 110, but rather are independent being spaced apart for sidewalls of adjacent cells by the flux trap spaces 202. The flux trap spaces 202 extend in two orthogonal directions between cells 110 in the horizontal X-Y plane and longitudinally along the height H of the tubes 120, as best shown in FIG. 4. Flux trap spaces 202 are comprised of flux trap spaces 202a defined between sidewalls 116 of adjacent tubes 120 measured along the X-axis each forming a gap having a distance d1 separating tubes, and flux trap spaces 202b defined between sidewalls 116 of adjacent tubes 120 measured along the Y-axis each forming a gap have a distance d2 separating tubes. In a preferred embodiment, flux trap spaces 202a and 202b are different so that the distances d1 and d2 are not equal as shown in FIG. 4. In this illustrated embodiment, distance d2 is greater than d1 creating a wider flux trap spaces between tubes along the X axis than the Y axis. The reverse arrangement may also be provided in other possible embodiments.

It will be appreciated that the result of the unequal flux trap spaces 202a and 202b is to create rectilinear polygonal fuel rack 200 shape in top plan view formed by the grid array of tubes 120 in which the overall total length LR of the rack and total width WR of the rack are unequal so that either the length LR is greater than the width WR, or vice-versa. In one embodiment, as shown in FIG. 4, this allows tubes 120 each having a square lateral cross-sectional configuration (i.e. Lc=Wc as shown in FIG. 3) to be used by relying on manipulation of the flux trap spaces 202 to form an overall fuel rack 200 shape in which the length Lr or width Wr is greater than the other. This arrangement provides the benefit of fully utilizing the available surface area of the fuel pool floor slab 106 for storing fuel assemblies in a flux trap type fuel rack.

In alterative embodiments, the tubes 120 in lateral cross section may each have a width Wc and length Lc which are different and unequal, and the flux trap spaces 202 may be different and unequal (i.e. flux trap spaces 202a and 202b and distances d1 and d2, respectively). In another embodiment, the tubes 120 in lateral cross section may each have a width Wc and length Lc which are different and unequal, and the flux trap spaces 202 may be the same and equal (i.e. flux trap spaces 202a and 202b and distances d1 and d2, respectively). Either of these alternative constructions and configurations of a flux trap fuel rack 200 may produce a fuel rack having an overall total length LR and total, width WR which are unequal so that either the length LR is greater than the width WR, or vice-versa.

It should be noted that gaps between tubes 120 created by flux trap spaces 202 act as a neutron flux trap that decreases and/or eliminates the danger of criticality. The flux trap space 202 can be designed to be any desired width and the exact width will depend on the radiation levels of the fuel assemblies to be stored, the material of construction of the tubes 120, and properties of the fuel pool water in which the fuel rack 100 will be submerged. In some possible representative embodiments, the flux trap spaces 202 may have a width between 30 and 50 millimeters, more preferably between 25 to 35 millimeters, and most preferably about 38 millimeters.

Spacers, which may be in foe form of spacing rods 204 in one embodiment, are inserted into the flux trap spaces 202 between tubes 120 to maintain the existence of the flux trap spaces 140 at the desired width and to provide added lateral structural stability to the fuel rack 200. Spacing rods 204 may extend for at least part of the height H of the tubes 120 as shown in FIG. 2 in which case a plurality of longitudinal spaced apart spacing rods may be provided in each flux trap space 202. In other possible embodiments, a single spacing rod 204 may be provided in each flux trap spaces 202 which extends for a majority of, and in some embodiments substantially the entire height H of the tube. Spacing rods 204 may have any suitable lateral cross-sectional configuration including without limitation round and rectilinear. The spacers are not limited to configurations such as spacing rods 204 alone, but in other embodiments may be composed of spacers having a wide variety of possible shapes and sizes including blocks, pins, weld studs, clips, etc. so long as the spacer is operable to maintain the flux trap spaces 202 between tubes.

In one embodiment, the spacing rods 204 are preferably made of metal such as without limitation aluminum or a metal matrix material, such as boron impregnated aluminum. The spacing rods 204 may be attached to tubes 120 by any suitable means used in the art including without limitation welding such as plug welding.

It should be noted that spacing rods 204 are omitted from FIG. 4 for clarity.

### III. Slotted-Plate Fuel Rack Embodiment

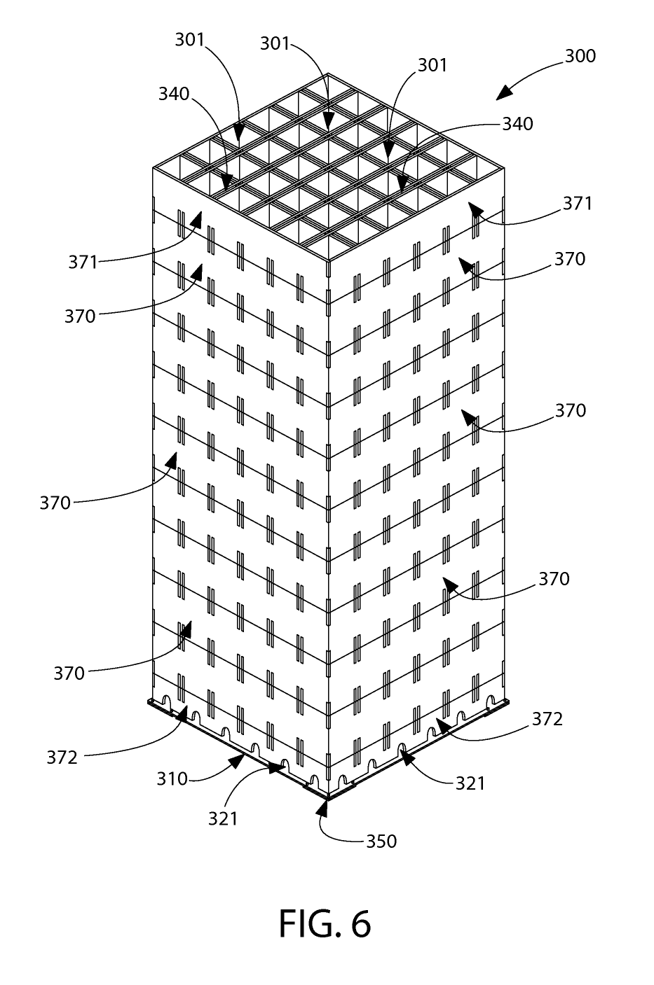

Referring now to FIGS. 6, 7A, 7B, 7C, and 8, a fuel rack 300 is formed from a plurality of slotted-plates arranged in a self-interlocking arrangement is illustrated. The fuel rack 300 is designed so as to have flux traps 340 analogous to fuel rack 200 described herein and rectilinear polygonal cells 301 in lateral or transverse cross section (in top plan view). Cells 301 are preferably rectangular in cross section and may each have a width Wc and length Lc which are equal forming a square with flux trap spaces 202 that are unequal in the manner already described above with respect to FIGS. 2 and 4.

It should be noted and understood that the slotted-plate concept described below can be utilized to form non-flux trap fuel racks similar to fuel rack 100 described herein without flux trap spaces 202, and in which cells 301 have a width Wc and length Lc which are different and unequal in some embodiments.

In describing the fuel rack 300 and its component parts below, relative terms such as top, bottom, above, below, horizontal, vertical upper and lower will be used in relation to the fuel rack 300 being in the illustrated substantially vertical orientation of FIG. 6. Additionally, in order to avoid clutter in the drawings, only a few of each component are numbered with the understanding that the reader will be able to identify duplicate elements.

Because many of the structural and functional features of the fuel rack 300 are identical to the fuel racks 100, 200 above, only those aspects of the fuel rack 300 that are significantly different will be discussed below with the understanding that the other concepts and structures discussed above with respect to the fuel racks 100, 200 are applicable.

The fuel rack 300 generally comprises an array of cells 301 that are formed by a gridwork of slotted plates 370-372 that are slidably assembled in an interlocking rectilinear arrangement. The gridwork of slotted plates 370-372 are positioned atop and connected to a base plate 310. The entire fuel rack body is formed out of three types of slotted plates, a middle plate 370, a top plate 371 and a bottom plate 372. The bottom plate comprises the auxiliary holes 321 as discussed above for facilitating thermosiphon flow into the cells 301.

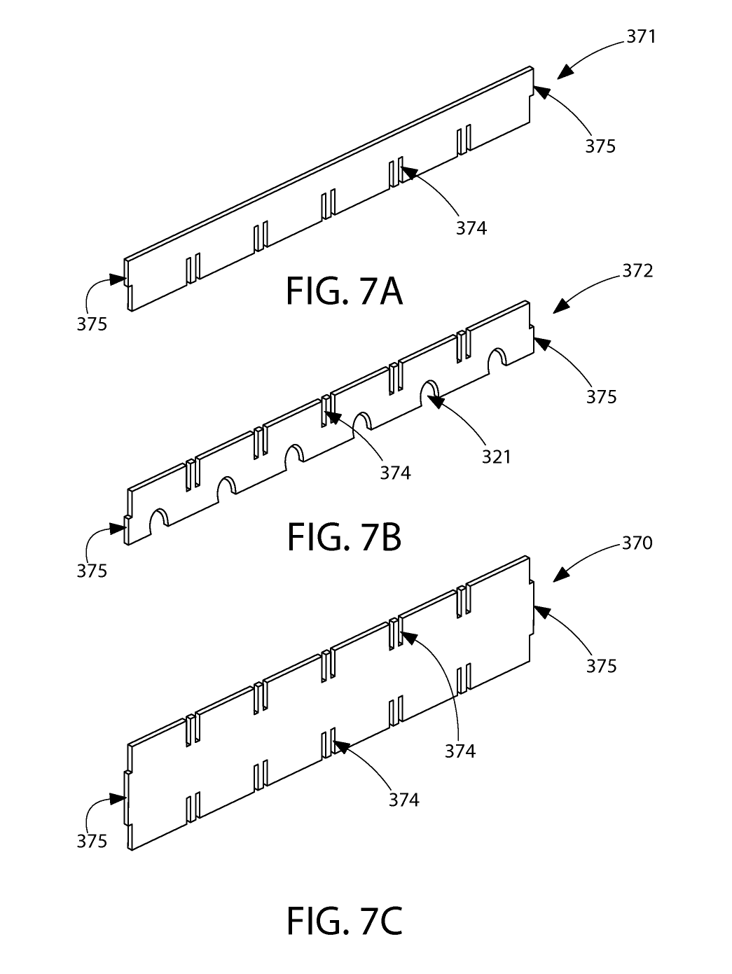

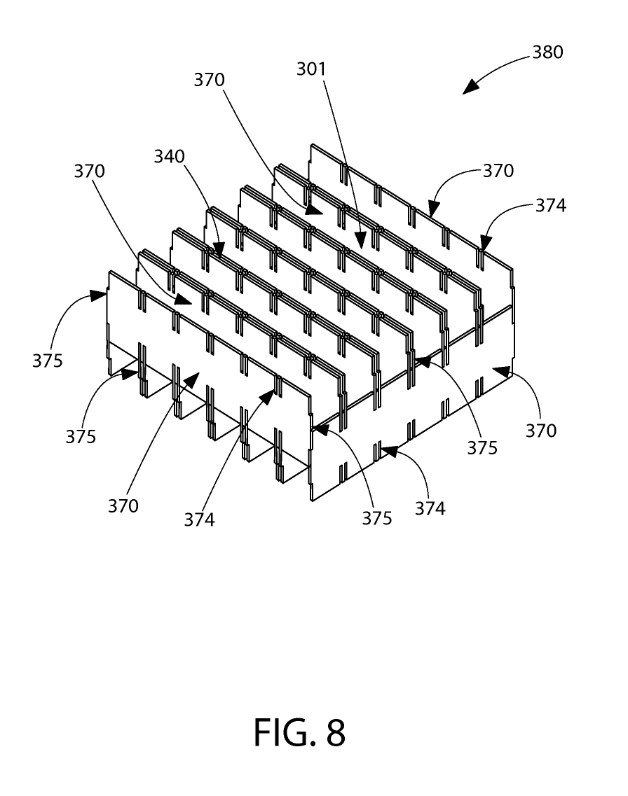

Referring now to FIGS. 7A-7C, one of the middle plates 370, top plates 371 and bottom plates 372 are illustrated individually. As can be seen, the bottom plate 372 is merely a top half of the middle plate 370 with the auxiliary holes 321 cutout at its bottom edge. Similarly, the top plate 371 is merely a bottom half of the middle plate 370. The bottom and top plates 372, 371 are only used at the bottom and top of the fuel rack body to cap the middle body segments 380 (FIG. 8) formed from the middle plates 370 so that the fuel rack body has a level top and bottom edge.

Each of the plates 370-372 comprise a plurality of slots 374 and end tabs 375 strategically arranged to facilitate sliding assembly to create the fuel rack body. The slots 374 are provided in both the top and bottom edges of the plates 370-372. The slots 374 on the top edge of each plate 370-372 are aligned with the slots 374 on the bottom edge of that same plate 370-372. The slots 374 extend through the plates 370-372 for one-fourth of the height of the plates 370-372. The end tabs 375 extend from lateral edges of the plates 370-372 and are preferably about one-half of the height of the plates 370-372. The end tabs 375 slidably mate with the indentations 376 in the lateral edges of adjacent plates 370-372 that naturally result from the existence of the tabs 375.

The plates 370-372 are preferably constructed of a metal-matrix composite material, and more preferably a discontinuously reinforced aluminum/boron carbide metal matrix composite material, and most preferably a boron Impregnated aluminum. One such suitable material is sold under the tradename Metamic™.

Referring now to FIG. 8, a single middle segment 380 of the basket is illustrated. Each middle segment 380 of the fuel rack 300 comprises a gridwork of middle plates 370 arranged in a rectilinear configuration so as to form a vertical portion of the cells 301 and the flux, traps 340. In creating a middle segment 380, a first middle plates 370 is arranged vertically. A second middle plate 370 is then arranged above and at a generally 90 degree angle to the first middle plate 370 so that its corresponding slots 374 are aligned. The second middle plate 370 is then lowered onto the first middle plate 370, thereby causing the slots 374 to interlock as illustrated. This is repeated with all middle plates 370 until the desired rectilinear configuration is created, thereby creating the segment 380.

In creating the fuel rack body, the slots 374 and end tabs 375 of the segments 380 interlock the adjacent segments 380 together so as to prohibit relative horizontal and rotational movement between the segments 380. The segments 380 intersect and interlock with one another to form a stacked assembly that is the fuel rack body. The fuel rack 300 preferably comprises at least four of the segments 380, and more preferably at least ten segments 380. All of the segments 380 have substantially the same height and configuration.

Therefore, the entire fuel rack 300 is formed of slotted plates 370-372 having what is essentially a single configuration which is the middle plate 370, with the exception that the top and bottom plates 371, 372 have to be formed by cutting the middle plate 370 and adding the cutouts 321.

Furthermore, as a result of the interlocking nature of the slotted plates 370-372, spacers are not needed to maintain the flux traps 340. Thus, in some embodiments, the fuel rack 300 will be free of spacers in the flux traps 340.

While the invention has been described and illustrated in sufficient detail that those skilled in this art can readily make and use it, various alternatives, modifications, and improvements should become readily apparent without departing from the spirit and scope of the invention.

1. A fuel rack for supporting radioactive fuel assemblies comprising:
a grid array of elongated cells defining a longitudinal axis and configured for immersion into a fuel pool, each cell comprising a plurality of walls having inner surfaces defining a longitudinally-extending cavity configured for holding a radioactive fuel assembly;
the cells having a rectilinear polygonal configuration in lateral cross section formed by a first pair of parallel spaced apart wails defining a length and a second pair of parallel spaced apart walls defining a width;
wherein the length is greater than the width of the cells.

2. The fuel rack of claim 1, wherein the grid array of cells is formed by a plurality of longitudinal tubes each having sidewalls with inner surfaces defining the cavity that forms the cell, the tubes being arranged in an axially aligned and adjacent manner.

3. The fuel rack of claim 2, wherein the sidewalls of each tube are disposed in abutting relationship with the sidewalls of adjacent tubes forming a contiguous array of tubes.

4. The fuel rack of claim 2, wherein at least some of the tubes share a common sidewall with at least one adjacent tube, the common sidewall forming part of at least two cells.

5. The fuel rack of claim 1, wherein the cells form a fuel rack having a length and a width, the length being greater than the width of the fuel rack.

6. The fuel rack of claim 1, wherein the cells are defined by longitudinally-extending tubes all having approximately the same length.

7. The fuel rack of claim 6, wherein the tubes ate constructed of a boron impregnated aluminum material.

8. The fuel rack of claim 6, wherein the tubes are attached to a base plate configured for placement on a floor slab of a fuel pool, and wherein the base plate is supported by a plurality of adjustable pedestals engaging the floor slab of the fuel pool.

9. (canceled)

10. The fuel rack of claim 1, wherein the cells are formed from a plurality of slotted-plates arranged in a self-interlocking arrangement, and wherein the slotted-plates form segments that intersect and interlock with one another to form a stacked assembly that forms a longitudinally extending fuel rack body.

11. (canceled)

12. A fuel rack for supporting radioactive fuel assemblies comprising:
a grid array of elongated tubes defining a longitudinal axis and configured for immersion into a fuel pool, each tube comprising a plurality of sidewalls having inner surfaces defining a longitudinally-extending cavity configured for holding a radioactive fuel assembly;
the tubes having a rectilinear polygonal configuration in lateral cross section formed by a first pair of parallel spaced apart sidewalks walls defining a length and a second pair of parallel spaced apart sidewalls defining a width;
the tubes each being spaced apart from one another forming flux trap spaces between sidewalls of adjacent tubes, the flux trap spaces comprising:
first flux trap spaces between tubes measured along a first orthogonal axis and forming a first gap having a first distance separating tubes, and
second flux trap spaces between tubes measured along a second orthogonal axis each forming a second gap have a second distance separating tubes;
wherein the first distance is different than the second distance.

13. The fuel rack of claim 12, wherein the tubes have a rectilinear polygonal configuration in lateral cross section.

14. The fuel rack of claim 12, wherein the tubes have a square rectilinear polygonal configuration in lateral cross section.

15. The fuel rack of claim 12, further comprising a plurality of spacers positioned in the flux trap spaces between the cells for maintaining the flux trap spaces.

16. The fuel rack of claim 12, wherein the tubes form a fuel rack having a length and a width, the length being greater than the width of the fuel rack.

17. (canceled)

18. (canceled)

19. The fuel rack of claim 12, wherein the tubes are attached to a base plate configured for placement on a floor slab of a fuel pool, and wherein the base plate is supported by a plurality of adjustable pedestals engaging the floor slab of the fuel pool.

20. (canceled)

21. The fuel rack of claim 12, wherein the tubes are formed from a plurality of slotted-plates arranged in a self-interlocking arrangement, the slotted-plates forming segments that intersect and interlock with one another to form a stacked assembly that forms a longitudinally extending fuel rack body.

22. (canceled)

23. The fuel rack of claim 12, wherein the tubes each comprise a first pair of parallel spaced apart sidewalls defining a length in top plan view and a second pair of parallel spaced apart sidewalls defining a width in top plan view, the length being greater than the width.

24. The fuel rack of claim 23, wherein the first distance of the first flux trap spaces between the tubes is substantially the same as the second distance of the second flux trap spaces between tubes.

25. A fuel storage system for radioactive fuel assemblies comprising:
a fuel pool comprising water and a floor slab defining a planar surface area;
a plurality of fuel racks positioned on the floor slab of the fuel pool, the fuel racks each comprising a grid array of elongated cells defining a longitudinal axis and being formed by a plurality of walls having inner surfaces defining a longitudinally-extending cavity configured for holding a radioactive fuel assembly;
each fuel rack having a length and a width in top plan view, the length and width being unequal;
wherein the plurality of fuel racks occupy greater than 85% of the available planar surface area of the floor slab of the fuel pool.

26. The fuel storage system of claim 25, wherein the plurality of fuel racks occupy greater than 90% of the available planar surface area of the floor slab of the fuel pool.

27. The fuel storage system of claim 25, wherein the plurality of fuel racks occupy greater than 95% of the available planar surface area of the floor slab of the fuel pool.

28. The fuel storage system of claim 25, wherein the plurality of fuel racks occupy approximately 100% of the available planar surface area of the floor slab of the fuel pool.
